(19) United States
(12) Patent Application Publication
(10) Pub. No.: US 2024/0031334 A1
(43) Pub. Date: Jan. 25, 2024

(54) IDENTITY FIREWALL WITH CONTEXT INFORMATION TRACKING

(71) Applicant: VMWARE, INC., Palo Alto, CA (US)

(72) Inventors: RAYANAGOUDA BHEEMANAGOUDA PATIL, Pune (IN); MANISHA SAMEER GAMBHIR PAREKH, Pune (IN); KULDEEP NAMADEORAO NIKAM, Pune (IN); SOUMEE PHATAK, Pune (IN)

(21) Appl. No.: 17/964,945

(22) Filed: Oct. 13, 2022

(30) Foreign Application Priority Data
Jul. 19, 2022 (IN) 202241041241

(51) Int. Cl. H04L 9/40

(52) U.S. Cl. CPC H04L 63/0236

(57) ABSTRACT

Example methods and systems for identity firewall with context information tracking are described. In one example, a first computer system may detect establishment of a connection with a virtualized computing instance, and track context information associated with the connection. The context information may include (a) first identity information that is associated with a prior connection between the client device and a second computer system, and (b) second identity information that is associated with the connection with the virtualized computing instance. Further, the first computer system may obtain a first identity firewall policy associated with the first identity information. In response to detecting a packet associated with a flow originating from, or destined for, the virtualized computing instance, the first computer system may allow or block forwarding of the packet based on the first identity firewall policy.

### RELATED APPLICATIONS

Benefit is claimed under 35 U.S.C. 119(a)-(d) to Foreign Application Serial No. 202241041241 filed in India entitled “IDENTITY FIREWALL WITH CONTEXT INFORMATION TRACKING”, on Jul. 19, 2022, by VMware, Inc., which is herein incorporated in its entirety by reference for all purposes.

### BACKGROUND

Virtualization allows the abstraction and pooling of hardware resources to support virtual machines in a software-defined data center (SDDC). For example, through server virtualization, virtualized computing instances such as virtual machines (VMs) running different operating systems may be supported by the same physical machine (e.g., host). Each VM is generally provisioned with virtual resources to run a guest operating system and applications. The virtual resources may include central processing unit (CPU) resources, memory resources, storage resources, network resources, etc. In practice, it is desirable to detect potential security threats that may affect the performance of hosts and VMs in the SDDC.

### BRIEF DESCRIPTION OF DRAWINGS

FIG. 1 is a schematic diagram illustrating a first example software-defined networking (SDN) environment in which identity firewall with context information tracking may be implemented;

FIG. 2 is a schematic diagram illustrating an example physical view of hosts in an SDN environment;

FIG. 3 is a flowchart of an example process for a first computer system to implement an identity firewall with context information tracking;

FIG. 4 is a flowchart of an example detailed process for a first computer system to implement an identity firewall with context information tracking;

FIG. 5 is a schematic diagram illustrating a first example of identity firewall with context information tracking in an SDN environment;

FIG. 6 is a schematic diagram illustrating a second example of identity firewall with context information tracking in an SDN environment;

FIG. 7 is a schematic diagram illustrating a first example of identity firewall with context information tracking in an SDN environment; and

FIG. 8 is a schematic diagram illustrating a second example of SDN environment in which identity firewall with context information tracking may be implemented.

### DETAILED DESCRIPTION

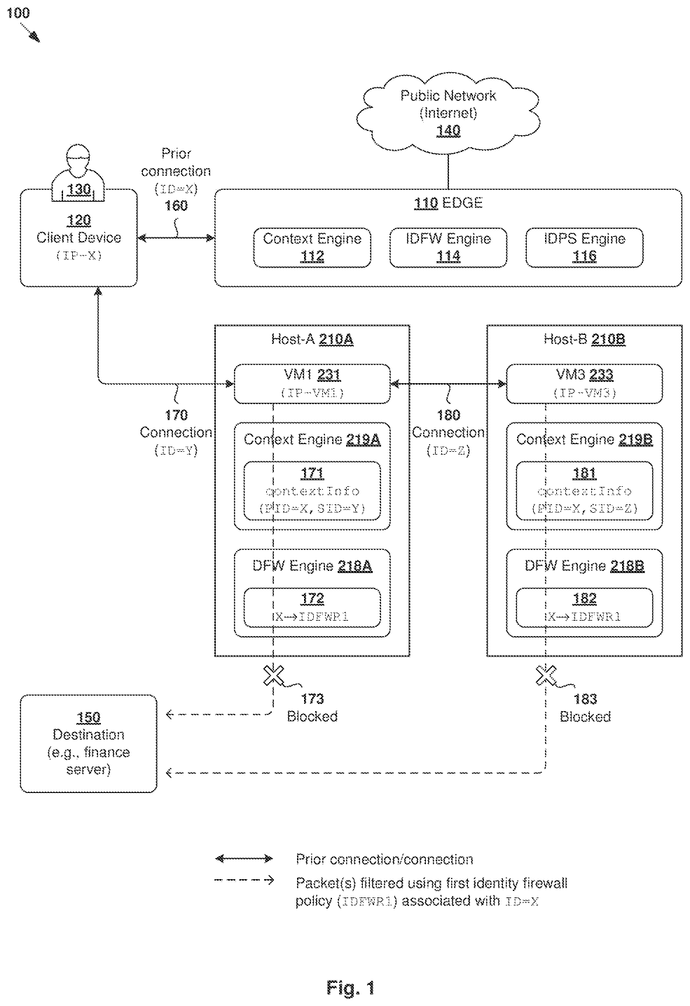

According to examples of the present disclosure, identity firewall with context information tracking may be implemented to improve data center security. One example may involve a first computer system (e.g., host 210A/210B in FIG. 1) detecting establishment of a connection with a virtualized computing instance (e.g., VM 231/233 in FIG. 1) supported by the first computer system. The establishment may be initiated by a client device operated by a user (e.g., 120-130 in FIG. 1). The first computer system may track context information associated with the connection. The context information may include (a) first identity information (e.g., ID=X in FIG. 1) that is associated with a prior connection between the client device and a second computer system (e.g., EDGE 110 in FIG. 1), and (b) second identity information (e.g., ID=Yin FIG. 1) that is associated with the connection with the virtualized computing instance.

The first computer system may obtain a first identity firewall policy associated with the first identity information. The first identity firewall policy may be different from a second identity firewall policy associated with the second identity information. In response to detecting a packet associated with a flow originating from, or destined for, the virtualized computing instance, the first computer system may allow or block forwarding of the packet based on the first identity firewall policy. Using examples of the present disclosure, data center security may be improved by reducing the likelihood of security attack(s) associated with privilege escalation and credential thefts. Various examples will be explained below using FIGS. 1-8.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used to describe various elements, these elements should not be limited by these terms. These terms are used to distinguish one element from another. For example, a first element may be referred to as a second element, and vice versa.

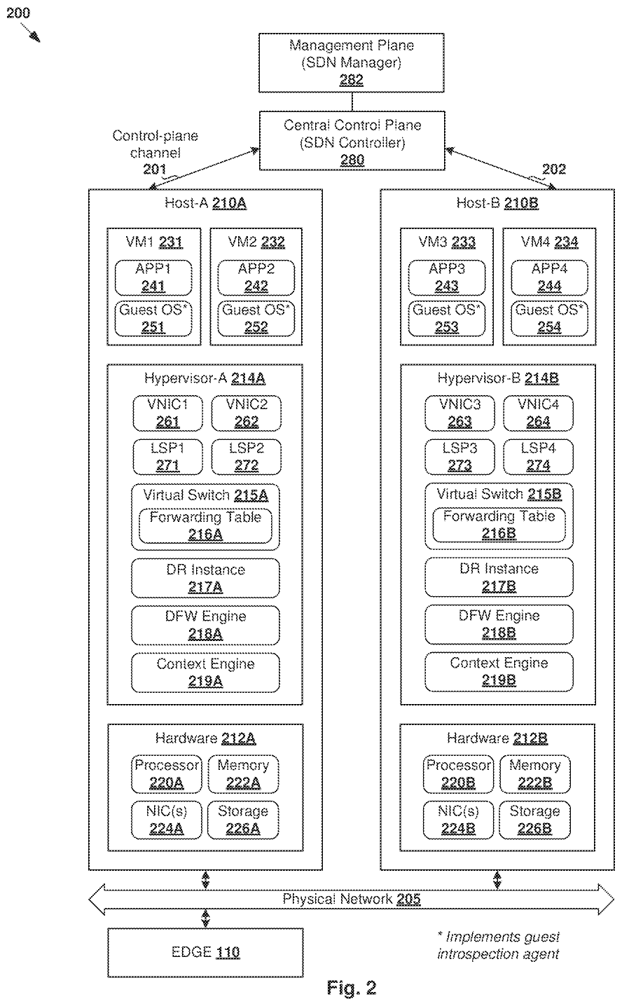

FIG. 1 is a schematic diagram illustrating first example software-defined networking (SDN) environment 100 in which identity firewall with context information tracking may be performed. FIG. 2 is a schematic diagram illustrating example physical view 200 of hosts in SDN environment 100. It should be understood that, depending on the desired implementation, SDN environment 100 may include additional and/or alternative components than that shown in FIG. 1 and FIG. 2. In practice, SDN environment 100 may include any number of hosts (also known as “computer systems,” “computing devices”, “host computers”, “host devices”, “physical servers”, “server systems”, “transport nodes,” etc.).

In the example in FIG. 1, SDN environment 100 may include EDGE 110 that is deployed at the edge of a data center to provide various networking services to host 210A/210B as well as client device 120 operated by user 130. Example services may include one or more of the following: gateway service (e.g., tier-0 gateway service), virtual private network (VPN) service, firewall service, domain name system (DNS) forwarding, IP address assignment using dynamic host configuration protocol (DHCP), source network address translation (SNAT), destination NAT (DNAT), deep packet inspection, etc. In the case of VPN service(s), such as secure sockets layer (SSL) VPN, client device 120 operated by remote user 130 may connect to EDGE 110 to access a private network (e.g., corporate domain) via EDGE 110. This way, user 130 may access server(s) and application(s) within the private network via EDGE 110.

In practice, an EDGE node may be an entity that is implemented using one or more virtual machines (VMs) and/or physical machines (known as “bare metal machines”) and capable of performing functionalities of a switch, router, bridge, gateway, edge appliance, or any combination thereof. EDGE 110 may be deployed to facilitate north-south traffic forwarding, such as between host 210A/210B and a remote destination that is located at a different geographical site. For example, packet(s) from source=VM1 231 on host-A 210A to a destination that is reachable via layer-3 network 140 (e.g., Internet) may be forwarded towards EDGE 110.

Physical Implementation View

Referring also to FIG. 2, host 210A/210B may include suitable hardware 212A/212B and virtualization software (e.g., hypervisor-A 214A, hypervisor-B 214B) to support various VMs. For example, host-A 210A may support VM1 231 and VM2 232, while VM3 233 and VM4 234 are supported by host-B 210B. Hardware 212A/212B includes suitable physical components, such as central processing unit(s) (CPU(s)) or processor(s) 220A/220B; memory 222A/222B; physical network interface controllers (PNICs) 224A/224B; and storage disk(s) 226A/226B, etc.

Hypervisor 214A/214B maintains a mapping between underlying hardware 212A/212B and virtual resources allocated to respective VMs. Virtual resources are allocated to respective VMs 231-234 to support a guest operating system (OS; not shown for simplicity) and application(s); see 241-244, 251-254. For example, the virtual resources may include virtual CPU, guest physical memory, virtual disk, virtual network interface controller (VNIC), etc. Hardware resources may be emulated using virtual machine monitors (VMMs). For example in FIG. 2, VNICs 261-264 are virtual network adapters for VMs 231-234, respectively, and are emulated by corresponding VMMs (not shown) instantiated by their respective hypervisor at respective host-A 210A and host-B 210B. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 214A-B may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-2” may refer generally to a link layer or media access control (MAC) layer; “layer-3” a network or Internet Protocol (IP) layer; and “layer-4” a transport layer (e.g., using Transmission Control Protocol (TCP), User Datagram Protocol (UDP), etc.), in the Open System Interconnection (OSI) model, although the concepts described herein may be used with other networking models.

SDN controller 280 and SDN manager 282 are example network management entities in SDN environment 100. One example of an SDN controller is the NSX controller component of VMware NSX® (available from VMware, Inc.) that operates on a central control plane. SDN controller 280 may be a member of a controller cluster (not shown for simplicity) that is configurable using SDN manager 282. Network management entity 280/282 may be implemented using physical machine(s), VM(s), or both. To send or receive control information, a local control plane (LCP) agent (not shown) on host 210A/210B may interact with SDN controller 280 via control-plane channel 201/202.

Through virtualization of networking services in SDN environment 100, logical networks (also referred to as overlay networks or logical overlay networks) may be provisioned, changed, stored, deleted and restored programmatically without having to reconfigure the underlying physical hardware architecture. Hypervisor 214A/214B implements virtual switch 215A/215B and logical distributed router (DR) instance 217A/217B to handle egress packets from, and ingress packets to, VMs 231-234. In SDN environment 100, logical switches and logical DRs may be implemented in a distributed manner and can span multiple hosts.

For example, a logical switch (LS) may be deployed to provide logical layer-2 connectivity (i.e., an overlay network) to VMs 231-234. A logical switch may be implemented collectively by virtual switches 215A-B and represented internally using forwarding tables 216A-B at respective virtual switches 215A-B. Forwarding tables 216A-B may each include entries that collectively implement the respective logical switches. Further, logical DRs that provide logical layer-3 connectivity may be implemented collectively by DR instances 217A-B and represented internally using routing tables (not shown) at respective DR instances 217A-B. Each routing table may include entries that collectively implement the respective logical DRs.

Packets may be received from, or sent to, each VM via an associated logical port. For example, logical switch ports 271-274 (labelled “LSP1” to “LSP4”) are associated with respective VMs 231-234. Here, the term “logical port” or “logical switch port” may refer generally to a port on a logical switch to which a virtualized computing instance is connected. A “logical switch” may refer generally to a software-defined networking (SDN) construct that is collectively implemented by virtual switches 215A-B, whereas a “virtual switch” may refer generally to a software switch or software implementation of a physical switch. In practice, there is usually a one-to-one mapping between a logical port on a logical switch and a virtual port on virtual switch 215A/215B. However, the mapping may change in some scenarios, such as when the logical port is mapped to a different virtual port on a different virtual switch after migration of the corresponding virtualized computing instance (e.g., when the source host and destination host do not have a distributed virtual switch spanning them).

A logical overlay network may be formed using any suitable tunneling protocol, such as Virtual eXtensible Local Area Network (VXLAN), Stateless Transport Tunneling (STT), Generic Network Virtualization Encapsulation (GENEVE), Generic Routing Encapsulation (GRE), etc. For example, VXLAN is a layer-2 overlay scheme on a layer-3 network that uses tunnel encapsulation to extend layer-2 segments across multiple hosts which may reside on different layer 2 physical networks. Hypervisor 214A/214B may implement virtual tunnel endpoint (VTEP) 219A/219B to encapsulate and decapsulate packets with an outer header (also known as a tunnel header) identifying the relevant logical overlay network (e.g., VNI). Hosts 210A-B may maintain data-plane connectivity with each other via physical network 205 to facilitate east-west communication among VMs 231-234.

Data Center Security

One of the challenges in SDN environment 100 is improving the overall data center security. For example, EDGE 110 may implement firewall engine 114 to provide firewall service(s) to VPN clients, such as client device 120 operated by user 130. This way, firewall engine 114 may filter packets belonging to a flow between source=client device 120 and a destination reachable via Internet 140. Similarly, to facilitate north-south traffic forwarding, firewall engine 114 may also filter packets belonging to a flow between a source VM (e.g., VM1 231) and a destination reachable via Internet 140, etc.

Further, to protect against security threats caused by unwanted packets, hypervisor 214A/114B may implement distributed firewall (DFW) engine 218A/218B to filter packets to and from associated VMs 231-234. For example, at host-A 210A, hypervisor 214A implements DFW engine 218A to filter packets for VM1 231 and VM2 232. At host-A 210B, hypervisor 214B implements DFW engine 218B to filter packets for VM3 233 and VM4 234. In practice, packets may be filtered at any point along the datapath from a source (e.g., VM1 231) to a physical NIC (e.g., 224A). In one embodiment, a filter component (not shown) may be incorporated into each of VNICs 241-244 to perform packet filtering for respective VMs 231-234.

Conventional firewall systems are generally configured to allow or deny access based on packet information. For example, conventional firewall rules generally specify (a) match field(s) specifying packet header and/or payload information to be matched with a packet and (b) an action to be performed if there is a match. This way, packets may be filtered based on the header and/or payload information, such as 5-tuple information that includes source IP address, source port number, destination IP address, destination port number and protocol.

More recently, the rise of user mobility has driven the need for identity firewall systems (also known as identity-based firewall systems) capable of filtering packets using identity firewall policies (also referred to as IDFWR). Compared to conventional firewall systems, identity firewall systems may allow or deny access to network resources based on a user's identity information. In practice, identity firewall systems may be implemented to support virtual desktop infrastructure (VDI) or remote desktop sessions, enabling simultaneous logins by multiple users, user application access based on requirements, and the ability to maintain independent user environments. Through VDI, user 130 may access various applications, such as word processing application, web browser, email application, videoconferencing application, etc.

In the example in FIG. 1, user 130 may be associated with domain username or user ID=X (e.g., John or john@xyz.com). Further, user 130 may be a member of group(s), such as Active Directory (AD) group=human resources (HR), etc. When user 130 logs into a corporate domain via EDGE 110, firewall engine 114 may filter packets to/from client device 120 based on identity firewall rules. When user 130 initiates a remote desktop protocol (RDP) session with server=VM 231/233 on host 210A/210B via EDGE 110, DFW engine 218A/218B may filter packets to/from associated VM 231/233 based on identity firewall rules.

In practice, SDN environment 100 is susceptible to various security threats, such as privilege escalation attacks that involve gaining access of elevated privileges beyond what is intended for a user, such as the user hopping machines by spoofing identities or secondary logins. Privilege escalation attacks may be vertical or horizontal. For example, vertical privilege escalation may involve an increase of privileges beyond what a user already has, such as an attacker taking advantage of system flaws, performing steps to bypass or override privilege controls, etc.

Horizontal privilege escalation may involve a user gaining access to the rights of another account. For example in FIG. 1, user 130 may log into a corporate domain via EDGE 110 using ID=X. Once user 130 has successfully logged in, user 130 may be given access according to firewall group policies. As such, if client device 120 is compromised, a malware may attempt to move around the data center to look for server access privileges from where it can steal data or unlock sensitive data. For example, a malware may attempt to impersonate other users and log on to different servers to escalate its privileges, such as server=VM1 231 on host-A 210A using ID=Y and another server=VM3 233 on host-A 210B using ID=Z. With each horizontal account compromised, an attacker may broaden their sphere of access, which is undesirable.

Identity Firewall with Context Information Tracking

According to examples of the present disclosure, an identity firewall with context information tracking may be implemented to improve data center security. Examples of the present disclosure may be implemented to reduce potential security threats associated with, inter alia, privilege escalation. As used herein, the term “security threat” or “malware” may be used as an umbrella term to cover hostile or intrusive software, including but not limited to botnets, viruses, worms, Trojan horse programs, spyware, phishing, adware, riskware, rootkits, spams, scareware, ransomware, or any combination thereof. The term “identity firewall” may refer generally to a firewall that is capable of applying identity firewall policy or policies configured based on a user's identity information to filter packets.

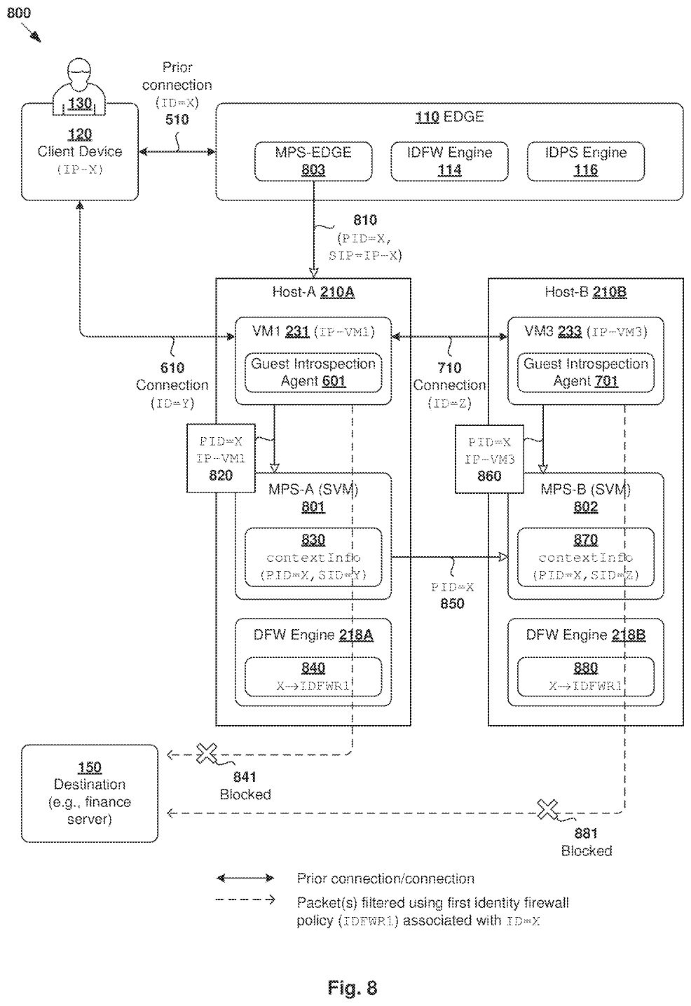

In the following, various examples will be discussed using host 210A/210B as an example “computer system” and VM 231/233 as an example “virtualized computing instance.” Host 210A/210B may implement examples of the present disclosure using any suitable hardware and/or software, such as DFW engine 218A/218B, context engine 219A/219B, etc. In the example in FIG. 2, DFW engine 218A/218B and context engine 219A/219B may be user-space processes running on hypervisor 214A/214B, DFW engine 218A/218B may be a plugin on context engine 219A/219B, etc. As will be described using FIG. 8, context engine 219A/219B may be deployed as a service VM (SVM) implemented by host 210A/210B. Further, EDGE 110 may implement examples of the present disclosure using any suitable hardware and/or software components, such as context engine 112, identity firewall (IDFW) engine 114, intrusion detection/prevention system (IDPS) 116, etc.

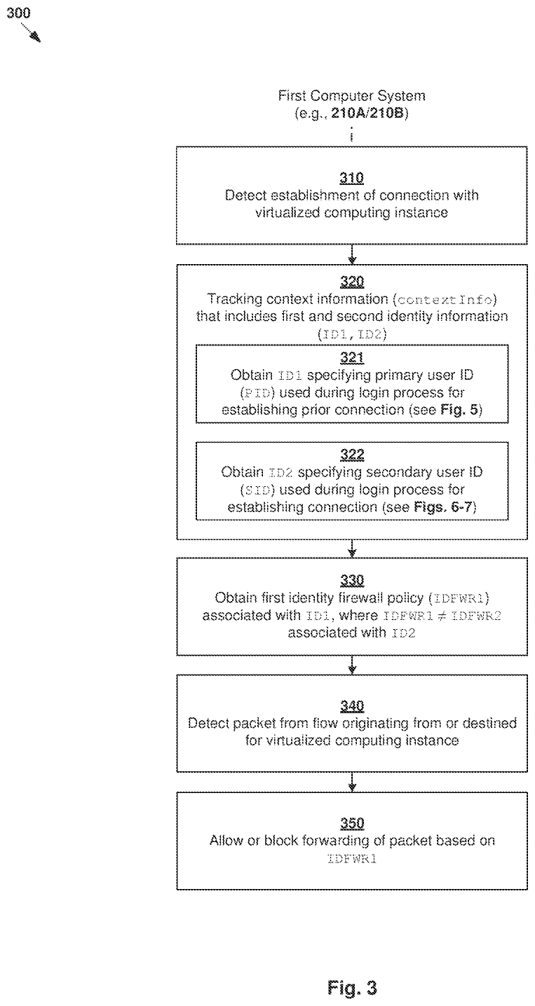

Some examples will be described using FIG. 3, which is a flowchart of example process 300 for a first computer system to implement an identity firewall with context information tracking. Example process 300 may include one or more operations, functions, or actions illustrated by one or more blocks, such as 310 to 350. Depending on the desired implementation, various blocks may be combined into fewer blocks, divided into additional blocks, and/or eliminated. The example in FIG. 3 will be explained using FIG. 1.

At 310 in FIG. 3, host 210A may detect establishment of a connection with VM1 231 (“first virtualized computing instance”). The connection establishment being initiated by client device 120 operated by user 130, such as a remote connection using RDP or similar protocol(s), etc. See 170 in FIG. 1.

At 320 in FIG. 3, host-A 210A may track context information (denoted as contextInfo) associated with the connection. The context information includes (a) first identity information and (b) second identity information. As used herein, the term “identity information” may refer generally to any suitable information for identifying a user, such as user ID in the form of a domain username (e.g., A=John or john@xyz.com), etc.

For example, at 321 in FIG. 3, the first identity information may be associated with a prior connection (see 160 in FIG. 1) between client device 120 and EDGE 110 (“second computer system”). At 322, the second identity information may be associated with the connection with VM1 231. Using the example in FIG. 1, the first identity information may specify primary user ID=X that is used during a login process with EDGE 110 to establish a VPN connection. The second identity information may specify secondary user ID=Y that is used during a login process for VM1 231 to establish an RDP connection for user 130 to access application(s) implemented by VM1 231. See 171 in FIG. 1, particularly primary user ID (denoted as PID)=X and secondary user ID (denoted as SID)=Y.

At 330 in FIG. 3, host-A 210A may obtain a first identity firewall policy (denoted as IDFWR1) associated with the first identity information (e.g., primary user ID=X). The term “obtaining” may refer generally to retrieving or receiving the first identity firewall policy from a source (e.g., management entity 280/282) or any suitable datastore (e.g., memory, database). The first identity firewall policy may differ from a second identity firewall policy (denoted as IDFWR2 below) associated with the second identity information (e.g., secondary user ID=Y). See 172 in FIG. 1.

At 340-350, in response to detecting a packet associated with a flow originating from, or destined for, VM1 231, host-A 210A may allow or block forwarding of the packet based on the first identity firewall policy. In the example in FIG. 1, a packet from VM1 231 to destination 150 may be blocked by DFW engine 218A based on the first identity firewall policy. See 173 in FIG. 1.

As will be described below, example process 300 in FIG. 3 may also be implemented by host-B 210B supporting VM3 233. Consider a scenario where client device 120 initiates the establishment of an RDP connection between VM1 231 and target VM3 233 using a different secondary user ID=Z. In this case, in response to detecting establishment of the RDP connection, host-B 210B may track context information associated with the connection, including (primary user ID=X, secondary user ID=Z). Similarly, the first identity firewall policy associated with primary user ID=X may be obtained and applied to filter packets from VM3 233. See 180-183 in FIG. 1.

According to examples of the present disclosure, the first identity firewall policy associated with the first identity information (e.g., primary user ID=X) may be obtained and applied on different identity firewall systems. Since the first identity firewall policy is retained regardless of user's nested logins with secondary credentials (e.g., secondary IDs=Y and Z) that might have been stolen, examples of the present disclosure may reduce the likelihood of vertical and/or horizontal privilege escalation attacks in SDN environment 100.

Examples of the present disclosure may be implemented to provide a tool for network administrators to configure a rule that limits the number of nested logins a user is allowed to perform so that users with malicious intention cannot go deeper and try to access sensitive information. Further, a whitelist of secondary user IDs that are allowed for a particular primary user ID may be configured. Other secondary user IDs that are not on the whitelist may be blocked. This way, genuine users (i.e., not stolen user credentials or escalated user privileges) are not blocked from accessing resource(s) in SDN environment 100. By tracking (primary user ID, secondary ID), multiple users with the same secondary user ID login (e.g., primary) may be tracked to resolve potential anomalies in the data center.

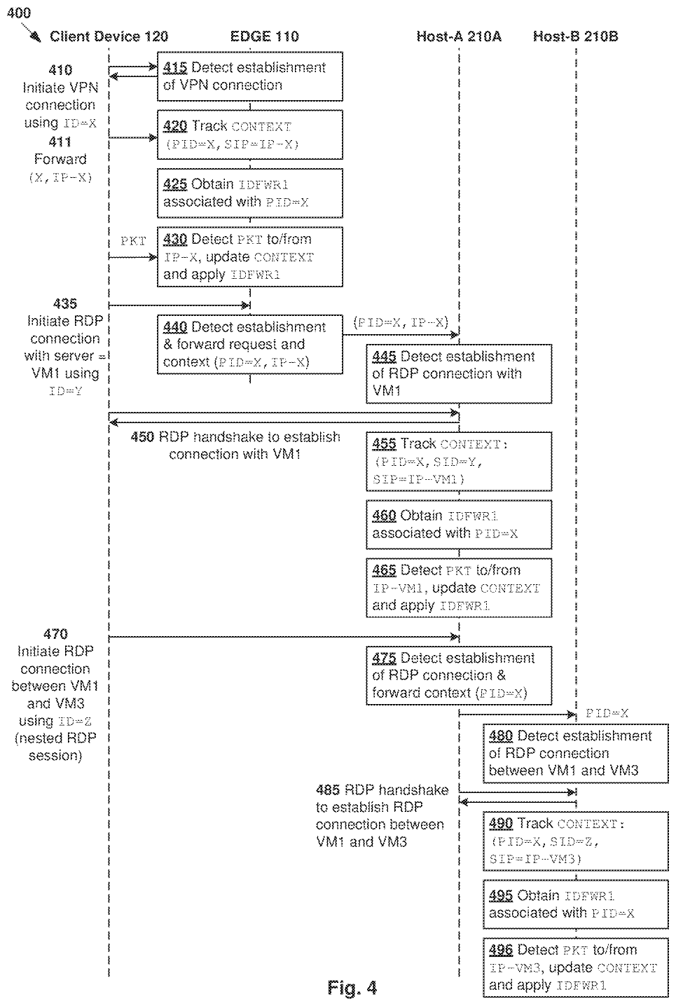

Examples of the present disclosure should be contrasted against approaches that necessitate more complex analysis or event log scrubbing for detecting privilege escalation. Such approaches are generally more resource-intensive and time-consuming. For example, approaches using artificial intelligence model(s) may be costly to implement and lack timeliness. Various examples will be discussed using FIGS. 4-8 below.

Example Prior Connection Using Primary User ID=X

FIG. 4 is a flowchart of example detailed process 400 for a first computer system to implement an identity firewall with context information tracking in an SDN environment. Example process 400 may include one or more operations, functions, or actions illustrated by one or more blocks, such as 410 to 496. Depending on the desired implementation, various blocks may be combined into fewer blocks, divided into additional blocks, and/or eliminated.

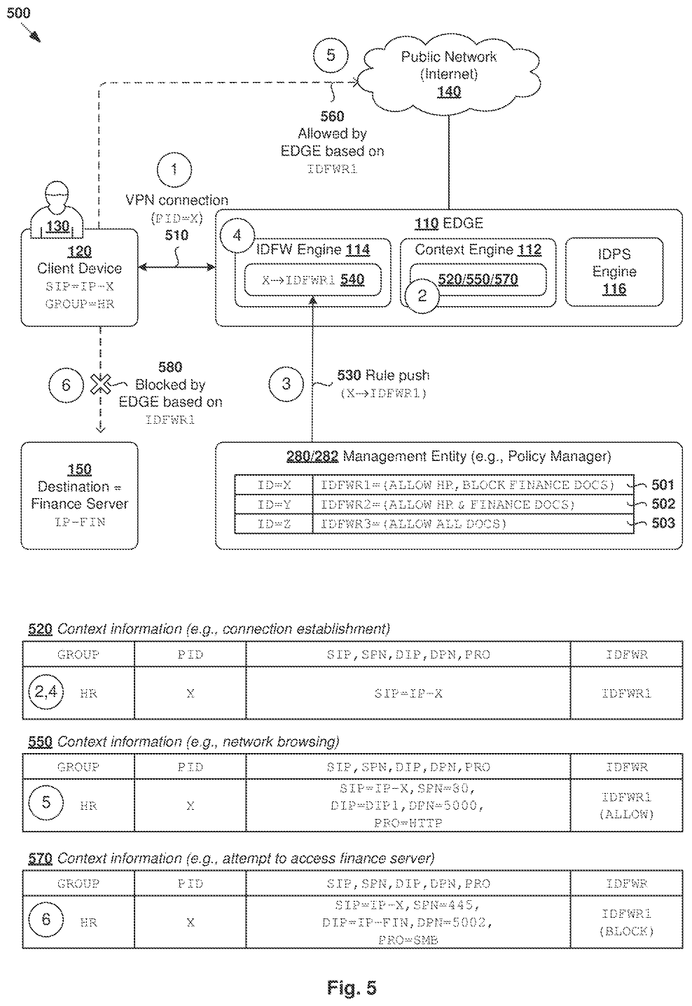

Blocks 410-430 in FIG. 4 will be explained using FIG. 5, which is a schematic diagram illustrating first example 500 of identity firewall with context information tracking in an SDN environment. The following notations will be used below: SIP=source IP address, DIP=destination IP address, SPN=source port number, DPN=destination port number and PRO=protocol, etc.

(a) Context Information

At 510 in FIG. 5, client device 120 operated by user 130 may initiate a prior connection to EDGE 110, such as a VPN connection to access a corporate domain, etc. Primary user ID=X may be used during a login process for client device 120 to establish the VPN connection with EDGE 110. In practice, for security reasons, user 130 may have to use the primary user ID (instead of secondary user IDs below) because AD credentials that include the primary user ID have been specifically allocated to physical client device 120 (e.g., laptop). Once connected to EDGE 110, corporate agent(s) installed on client device 120 may assign a corporate IP address (e.g., IP-X=192.168.1.2) to client device 120. The corporate agent(s) may also send mapping (primary user ID=X, IP address=IP-X) to context engine 112 implemented by EDGE 110. See also 410-411 in FIG. 4.

At 520 in FIG. 5, in response to detecting establishment of the VPN connection initiated by client device 120, EDGE 110 (e.g., context engine 112) may track context information associated with the connection. In this example, context information 520 generated by context engine 112 may specify (a) group membership information, such as AD group=HR group of which user 130 is a member, (b) first identity information specifying primary user ID=X associated with user 130, (c) network connection information (e.g., 5-tuple information) that includes SIP=IP-X and (d) an associated firewall policy to be described below. In practice, group membership information (e.g., group=HR) may be obtained from an event log scrapper (not shown) implemented by management entity 280/282. See also 415-420 in FIG. 4.

(b) Identity Firewall Policy

At 530-540 in FIG. 5, EDGE 110 (e.g., using context engine 112 and/or firewall engine 114) may obtain a first identity firewall policy (denoted as “IDFWR1”) associated with primary user ID=X. In practice, EDGE 110 may obtain (e.g., receive or retrieve) the first identity firewall policy from management entity 280/282. Context information 520 may also track the mapping between primary user ID=X and first identity firewall policy. See also 425 in FIG. 4.

In the example in FIG. 5 (see 501-503), management entity 280/282 may maintain mapping information associating multiple sets of identity information with respective identity firewall policies, such as (ID=X, policy=IDFWR1), (ID=Y, policy=IDFWR2) and (ID=Z, policy=IDFWR3). Here, IDFWR1 501 may be configured to allow access to HR documents, but block access to finance documents. IDFWR2 502 may be configured to allow access to both HR and finance documents. IDFWR3 503 may be configured to allow access to all documents. In practice, each identity firewall policy may include one or more firewall rules, and applicable to egress and/or ingress packets.

At 550/570 in FIG. 5, in response to detecting packet(s) addressed to/from IP-X associated with client device 120, context engine 112 implemented by EDGE 110 may generate context information 550 by adding (SPN, DIP, DPN, PRO) extracted from the packet(s). Further, at 560/580, firewall engine 114 may apply IDFWR1 501 to allow or block forwarding of the packets. See also 430 in FIG. 4.

Two example north-south packet flows are shown in FIG. 5. In a first example (see 550-560), user 130 operating client device 120 may perform web browsing activity. In this case, in response to detecting egress packet(s) addressed from SIP=IP-X associated with client device 120 to DIP=DIP1 (e.g., well-known IP address associated with a search engine) accessible via Internet 140, firewall engine 114 may apply IDFWR1 501 to allow forwarding of the packet(s).

In a second example (see 570-580 in FIG. 5), user 130 operating client device 120 may attempt to access finance documents, an activity that is not allowed by IDFWR1 501 associated with primary user ID=X. In this case, in response to detecting egress packet(s) addressed from SIP=IP-X to DIP=IP-FIN (e.g., 192.168.1.250) associated with destination=finance server 150, firewall engine 114 may apply IDFWR1 501 to block forwarding of the packet(s).

Example Connection Using Secondary User ID=Y

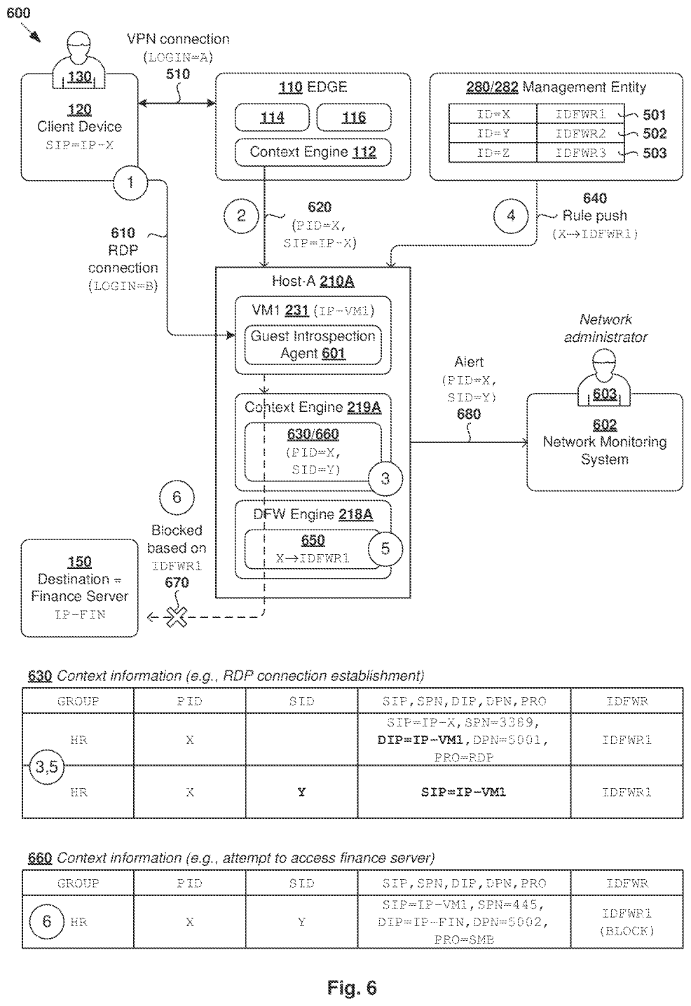

Blocks 435-465 in FIG. 4 will be explained using FIG. 6, which is a schematic diagram illustrating second example 600 of identity firewall with context information tracking in SDN environment 100. Using the example in FIG. 5, client device 120 has established a prior VPN connection (see 510 in FIGS. 5-6) with EDGE 110 using primary user ID=X during a login process. Although exemplified using RDP connections, any alternative and/or additional protocol(s) may be used in practice, such as secure shell (SSH), Telnet, file transfer protocol (FTP), trivial FTP (TFTP), secure copy protocol (SCP), etc.

(a) Context Information

At 610 in FIG. 6, client device 120 may initiate the establishment of a connection with VM1 231 using any suitable protocol, such as RDP, etc. The connection may be established to facilitate a remote desktop session where user 130 may access application(s) implemented by VM1 231. In this example, secondary user ID=Y is used during a login process for the RDP connection instead of the primary user ID=X used for the VPN connection in FIG. 5. See also 435 in FIG. 4.

Conventionally, there is a risk of privilege escalation attacks if user 130 is allowed to access resources (e.g., sensitive documents) using secondary user ID=Y that would be otherwise denied using primary user ID=X. Using examples of the present disclosure, the likelihood of such privilege escalation attacks may be reduced, if not avoided, by applying the same identity firewall policy associated with primary user ID=X instead that of secondary user ID=Y.

At 620 in FIG. 6, in response to detecting the establishment of the connection between client device 120 and VM1 231, context engine 112 on EDGE 110 may forward context information specifying (primary user ID=X, SIP=IP-X) towards context engine 219A on host-A 210A. In practice, the establishment of the connection may be detected using IDPS engine 116, which then informs context engine 112. Depending on the desired implementation, EDGE 110 may forward an RDP connection request packet received from client device 120 towards host-A 210A to facilitate the establishment process. See also 440 in FIG. 4.

Context engine 112 may perform any suitable span calculation approach to push (primary user ID=X, SIP=IP-X) towards host-A 210A. Context engine 112 may also send the context information to any suitable entity, such as a security and analytics platform (e.g., VMware NSX® Intelligence™) for analysis, etc. Any suitable handshake process may be implemented for establishing an RDP connection, such as connection initiation, basic settings exchange, channel connection, RDP security commencement, secure settings exchange, connect-time auto-detection, licensing, multi-transport bootstrapping, capabilities exchange, connection finalization, etc. See 450 in FIG. 4.

At 630 in FIG. 6, in response to detecting establishment of the RDP connection with VM1 231, context engine 219A on host-A 210A may track context information associated with the RDP connection, including a mapping between primary user ID=X associated with the prior VPN connection and secondary user ID=Y associated with the RDP connection. See also 445 and 455 in FIG. 4.

For example, a first entry of context information 630 may specify (a) group=HR associated with user 130, (b) primary user ID=X associated with the prior connection with EDGE 110, and (c) network connection information (SIP=IP-X, SPN=3389, DIP=IP-VM1, DPN=5001, PRO=RDP). Further, a second entry of context information 630 may specify (a) group=HR, (b) primary user ID=X, (c) secondary user ID=Y, and (d) SIP=IP-VM1 associated with VM1 231.

Context information 630 may be generated based on information obtained from context engine 219A and/or guest introspection agent 601 associated with VM1 231. For example, guest introspection agent 601 implemented by guest OS 251 on VM1 231 may be configured to detect the RDP connection establishment and forward (primary user ID=X, IP address=IP-VM1) to context engine 219A.

Depending on the desired implementation, guest introspection agent 601/701 may register hooks (e.g., callbacks) with kernel-space or user-space module(s) implemented by guest OS 251/253 for new network connection events, etc. For example, in response to detecting a SSH session initiated by VM1 231, guest introspection agent 601/701 receives a callback from the guest OS and sends context information to context engine 219A/219B. Guest introspection agent 601/701 may be a guest OS driver configured to interact with packet processing operations taking place at multiple layers in a networking stack of guest OS 251/253 and intercept file and/or network-related events.

(b) Identity Firewall Policy

At 640-650 in FIG. 6, host-A 210A (e.g., context engine 219A and/or DFW engine 218A) may obtain first identity firewall policy=IDFWR1 501 associated with primary user ID=X and group=HR, such as from management entity 280/282. Context information 630 tracked by context engine 219A may further specify IDFWR1 501 associated with primary user ID=X. See 460 in FIG. 4.

As explained using FIG. 5, IDFWR1 501 may be configured for group=HR (of which primary user ID=X is a member) to access to HR documents, but block access to finance documents. IDFWR2 502 may be configured to allow access to both HR and finance documents. Examples of the present disclosure should be contrasted against conventional approaches that cause host-A 210A to apply IDFWR2 502 because secondary user ID=Y is used during the login process.

At 660 in FIG. 6, in response to detecting packet(s) addressed to/from IP-VM1 associated with VM1 231, context engine 219A on host-A 210A may generate context information 660 that includes (SIP=IP-VM1, SPN=445, DIP=IP-FIN, DPN=5002, PRO=SMB) extracted from the packet(s). In practice, server message block (SMB) is a client-server communication protocol for network file sharing, etc. Further, at 670, DFW engine 218A may apply IDFWR1 501 associated with primary user ID=X to allow or block forwarding of the packet(s). See also 465 in FIG. 4.

In the example in FIG. 6, user 130 may be malicious and/or client device 120 infected by malware. In this case, client device 120 may attempt to access finance documents, an activity that is not allowed by IDFWR1 501 associated with primary user ID=X but allowed for secondary user ID=Y. In this case, in response to detecting egress packet(s) addressed from SIP=IP-VM1 to DIP=IP-FIN associated with finance server 150, DFW engine 218A may apply IDFWR1 501 to block forwarding of the packet(s), thereby preventing user 130 from accessing finance documents.

Example Connection Using Secondary User ID=Z

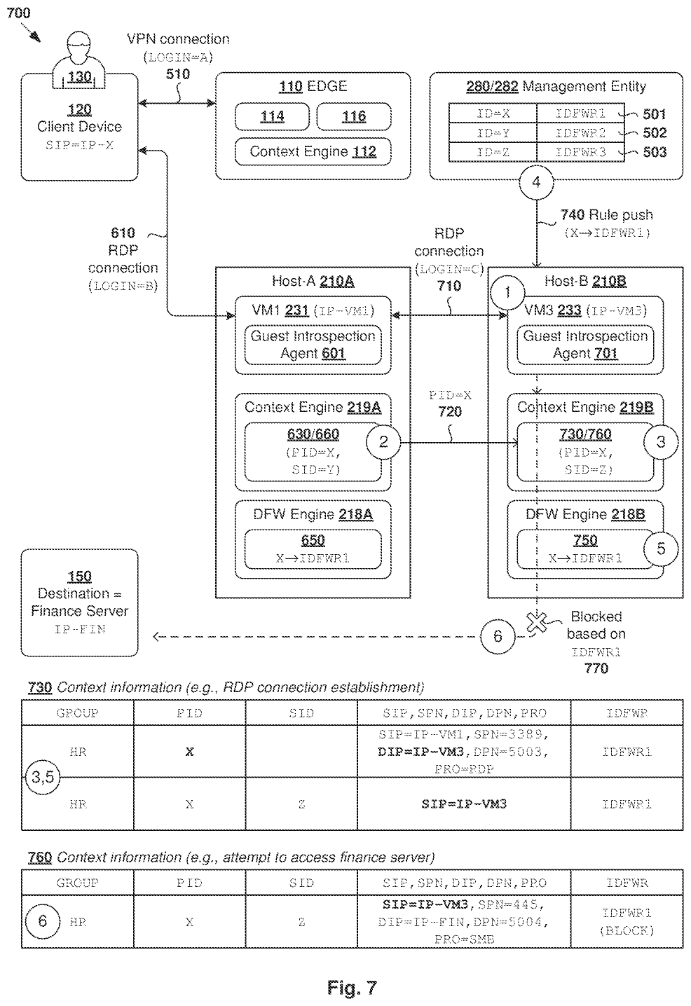

Blocks 470-496 in FIG. 4 will be explained using FIG. 7, which is a schematic diagram illustrating third example 700 of identity firewall with context information tracking in SDN environment 100. Using the example in FIG. 5, client device 120 has established prior connection=VPN connection (see 510 in FIGS. 5-6) with EDGE 110 using primary user ID=X during a login process.

(a) Context Information

At 710 in FIG. 7, client device 120 may initiate the establishment of an RDP connection between VM1 231 on host-A 210A and VM3 233 on host-B 210B. This is also known as a nested RDP connection/session. In this example, secondary user ID=Z is used during a login process for the RDP connection instead of the primary user ID=X used for the VPN connection in FIG. 5. See also 470 in FIG. 4.

At 720 in FIG. 7, in response to detecting the establishment of the RDP connection between VM1 231 and VM3 233, context engine 219A on host-A 210A may forward context information specifying primary user ID=X towards context engine 219B on host-B 210B. See also 475 in FIG. 4.

At 730 in FIG. 7, in response to detecting establishment of the RDP connection between VM1 231 and VM3 233, context engine 219A on host-B 210B may track context information 730 associated with the RDP connection, including a mapping between (a) primary user ID=X associated with the prior VPN connection and (b) secondary user ID=Z associated with the RDP connection. Context information 730 may be generated based on information obtained from context engine 219B and/or guest introspection agent 701 associated with VM3 233. See also 480-490 in FIG. 4.

For example, a first entry of context information 730 may specify (a) group=HR associated with user 130, (b) primary user ID=X associated with the prior connection with EDGE 110, and (c) network connection information (SIP=IP-VM1, SPN=3389, DIP=IP-VM3, DPN=5003, PRO=RDP). Further, a second entry of context information 730 may specify (a) group=HR, (b) primary user ID=X, (c) secondary user ID=Z, and (d) SIP=IP-VM3 associated with VM3 233.

(b) Identity Firewall Policy

At 740-750 in FIG. 7, host-B 210B (e.g., context engine 219A and/or DFW engine 218A) may obtain first identity firewall policy=IDFWR1 501 associated with primary user ID=X and group=HR, such as from management entity 280/282. Context information 730 tracked by context engine 219A may further specify first identity firewall policy=IDFWR1 501 associated with primary user ID=X. See 495 in FIG. 4.

As explained using FIG. 5, IDFWR1 501 may be configured to allow access to HR documents, but block access to finance documents. IDFWR3 503 associated with secondary user ID=Z (e.g., admin) may be configured to allow access to all documents. Examples of the present disclosure should be contrasted against conventional approaches that necessitate host-B 210B to apply IDFWR3 503 because secondary user ID=Z is used during the login process.

At 760 in FIG. 7, in response to detecting packet(s) addressed to/from IP-VM3 associated with VM3 233, context engine 219B implemented by host-B 210B may generate context information 760 specifying (SIP=IP-VM3, SPN=445, DIP=IP-FIN, DPN=5004, PRO=SMB) extracted from the packet(s). Further, at 770, DFW engine 218B may apply IDFWR1 501 associated with primary user ID=X to allow or block forwarding of the packet(s). See 496 in FIG. 4.

In the example in FIG. 7, user 130 may be malicious and/or client device 120 infected by malware. In this case, client device 120 may attempt to access finance documents, an activity that is not allowed by IDFWR1 501 associated with primary user ID=X but allowed for secondary user ID=Z, which might have been stolen from another user. In this case, in response to detecting egress packet(s) addressed from SIP=IP-VM3 to DIP=IP-FIN associated with destination=finance server 150, DFW engine 218B may apply IDFWR1 501 to block forwarding of the packet(s), thereby reducing if not eliminating the likelihood of privilege escalation attacks using the secondary user ID=Z.

Although not shown in FIG. 7, it should be understood that a nested RDP connection/session may be established between two VMs on the same host, such as VM1 231 and VM2 232 residing on host-A 210A. In this case, context engine 219A may perform blocks 480-496 in FIG. 4, and update its context information to include the mapping between primary user ID=X and secondary user ID=Z.

Security Alerts

Depending on the desired implementation, host 210A/210B may be configured to generate and send an alert or alarm notification to report that different user credentials are used for multiple logins. For example in FIG. 6, alert 680 may be generated and sent to network monitoring system 602 accessible by network administrator(s) 603. Alert 680 may specify that secondary user ID=Y is different from primary user ID=X. Although not shown in FIG. 7 for simplicity, host-B 210B may generate and send an alert to report that secondary user ID=Z is different from primary user ID=X to help identify a potential security attack using nested RDP.

Such security alert(s) may be inspected by security operation center(s) and/or network operation center(s) to facilitate one or more of the following to help early tracking of potential security attacks in SDN environment 100. The security alert(s) may also facilitate at least one of the following to further strengthen data center security: endpoint detection and response (EDR), network detection and response (NDR) and extended detection and response (XDR).

In practice, context information generated by host 210A/210B may further track the number of nested logins. In response to detecting that the number exceeds a predetermined threshold, an alert or alarm notification may be generated and sent to indicate that user 130 is hopping around too much. In this case, a policy that limits the number of nested logins may be enforced to block an attempt to establish a further RDP connection, such as between VM3 233 on host-B 210B and another target VM.

Example Using Malware Protection Service (MPS) Instances

Examples of the present disclosure may be implemented as part of a malware protection or anti-malware system in SDN environment 100. Some examples will be explained using FIG. 8, which is a schematic diagram illustrating second example 800 of an SDN environment in which identity firewall with context information tracking may be implemented. In the example in FIG. 2, context engine 219A/219B may be implemented using hypervisor 214A/214B on host 210A/210B. Alternatively, using the example in FIG. 8, context engine 219A/219B may be deployed in the form of an SVM (see 801/802) supported by host 210A/210B.

In more detail, SVM 801 on host-A 210A may represent a first malware protection service (MPS) instance (denoted as MPS-A) to provide malware protection for VMs 231-232. SVM 802 on host-B 210B may represent a second MPS instance (denoted as MPS-B) to provide malware protection for VMs 233-234. Depending on the desired implementation, DFW engine 218A/218B may be implemented as part of MPS instance 801/802 (or as a separate component). Similarly, EDGE 110 may include MPS instance 803 (denoted as MPS-EDGE) to implement functionalities of context engine 112 according to examples of the present disclosure. IDFW engine 114 and/or IDPS engine 116 may be part of MPS instance 803 on EDGE 110 (or as separate components). As used herein, the term “context engine” may refer generally to component(s) on host 210A/210B capable of implementing functionalities of hypervisor-implemented context engine 219A/219B and/or SVM 801/802 according to examples of the present disclosure.

In the example in FIG. 8, user 130 operating client device 120 may initiate the establishment of a VPN connection (see 510) with EDGE 110, a first RDP connection (see 610) with VM1 231 on host-A 210A, and a second RDP connection (see 710) between VM1 231 and VM3 233. In this case, MPS-EDGE 803 on EDGE 110 may track context information associated with VPN connection 510. At 810, in response to detecting the establishment of the first RDP connection with VM1 231, MPS-EDGE 803 on EDGE 110 may forward context information specifying (primary user ID=X, SIP=IP-X) towards MPS-A 801 on host-A 210A.

At 820-830 in FIG. 8, in response to detecting the establishment of the first RDP connection between client device 120 and VM1 231, MPS-A 801 may track context information (denoted as contextInfo) associated with the connection. The context information may be generated based on network event information 820 specifying (primary user ID=X, SIP=IP-VM1) from guest introspection agent 601, which is capable of capturing network event information for new connection(s) on VM1 231. The context information may include (a) primary user ID=X associated with prior VPN connection 510 and (b) secondary user ID=Y associated with RDP connection 610. See examples at 630 and 660 in FIG. 6.

At 840-841 in FIG. 8, IDFWR1 501 associated with primary user ID=X may be obtained and applied to packet(s) to/from VM1 231. For example, packet(s) from VM1 231 to destination 150=finance server may be blocked by DFW engine 218A based on IDFWR1 501, which allows access to HR documents but block access to finance documents. This way, IDFWR1 501 associated with primary user ID=X may be applied instead of IDFWR2 502 associated with secondary user ID=Y. Further, at 850, in response to detecting the establishment of the RDP connection between VM1 231 and VM3 233, MPS-A 801 may forward context information that includes primary user ID=X towards MPS-B 802 on host-B 210B.

At 860-870 in FIG. 8, in response to detecting establishment of the RDP connection between VM1 231 and VM3 233, MPS-B 802 may track context information associated with the RDP connection, including a mapping between (a) primary user ID=X associated with prior VPN connection 510 and (b) secondary user ID=Z associated with RDP connection 710. Context information 870 may be generated based on network event information 860 specifying (primary user ID=X, SIP=IP-VM3) from guest introspection agent 701, which is capable of capturing network event information for new connection(s) on VM3 233. See examples at 730 and 760 in FIG. 7.

At 880-881 in FIG. 8, IDFWR1 501 associated with primary user ID=X may be obtained and applied to packet(s) to/from VM3 233. For example, packet(s) from VM3 233 to destination 150=finance server may be blocked by DFW engine 218B based on IDFWR1 501. This way, IDFWR1 501 associated with primary user ID=X may be applied instead of IDFWR3 503 associated with secondary user ID=Z. Various implementation details explained using FIGS. 1-7 are also applicable to the example in FIG. 8 and will not be repeated in full for brevity.

Container Implementation

Although discussed using VMs 231-234, it should be understood that identity firewall with context information tracking may be performed for other virtualized computing instances, such as containers, etc. The term “container” (also known as “container instance”) is used generally to describe an application that is encapsulated with all its dependencies (e.g., binaries, libraries, etc.). For example, multiple containers may be executed as isolated processes inside VM1 231, where a different VNIC is configured for each container. Each container is “OS-less”, meaning that it does not include any OS that could weigh 10s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies.

Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 8. For example, a computer system capable of acting as host 210A/210B or EDGE 110 may be deployed in SDN environment 100 to perform examples of the present disclosure.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described or can be alternatively located in one or more devices different from that in the examples. The units in the examples described can be combined into one module or further divided into a plurality of sub-units.

What is claimed is:

1. A method for a first computer system to implement an identity firewall with context information tracking, wherein the method comprises:
detecting establishment of a connection with a virtualized computing instance supported by the first computer system, wherein the establishment is initiated by a client device operated by a user;
tracking context information associated with the connection, wherein the context information includes (a) first identity information that is associated with a prior connection between the client device and a second computer system, and (b) second identity information that is associated with the connection with the virtualized computing instance;
obtaining a first identity firewall policy associated with the first identity information, the first identity firewall policy being different from a second identity firewall policy associated with the second identity information; and
in response to detecting a packet associated with a flow originating from, or destined for, the virtualized computing instance, allowing or blocking forwarding of the packet based on the first identity firewall policy.

2. The method of claim 1, wherein tracking the context information comprises:
obtaining the first identity information specifying a primary user identifier (ID) that is used during a login process for the client device to establish the prior connection with the second computer system.

3. The method of claim 1, wherein tracking the context information comprises:
obtaining the second identity information specifying a secondary user identifier (ID) that is used during a login process for the client device to establish the connection with the first computer system.

4. The method of claim 1, wherein tracking the context information comprises:
tracking the context information that includes the first identity information, the second identity information and one or more of the following: (a) group membership information associated with the user; and (b) tuple information that includes source address information, source port number, destination address information and destination port number.

5. The method of claim 1, wherein tracking the context information comprises:
obtaining the first identity information or the second identity information, or both, from one or more of the following: a context engine implemented by the second computer system, and a guest introspection agent associated with the virtualized computing instance.

6. The method of claim 1, wherein detecting establishment of the connection comprises:
detecting a request to establish a remote desktop protocol (RDP) connection for the user to access at least one application implemented by the virtualized computing instance via the client device.

7. The method of claim 1, wherein the method further comprises:
detecting a request to establish a further connection between the virtualized computing instance supported by the first computer system and a target virtualized computing instance supported by a third computer system; and
forwarding context information that includes the first identity information towards the third computer system to cause application of the first identity firewall policy associated with the first identity information on the third computer system.

8. A non-transitory computer-readable storage medium that includes a set of instructions which, in response to execution by a processor of a computer system, cause the processor to perform a method of identity firewall with context information tracking, wherein the method comprises:
detecting establishment of a connection with a virtualized computing instance supported by the first computer system, wherein the establishment is initiated by a client device operated by a user;
tracking context information associated with the connection, wherein the context information includes (a) first identity information that is associated with a prior connection between the client device and a second computer system, and (b) second identity information that is associated with the connection with the virtualized computing instance;
obtaining a first identity firewall policy associated with the first identity information, the first identity firewall policy being different from a second identity firewall policy associated with the second identity information; and
in response to detecting a packet associated with a flow originating from, or destined for, the virtualized computing instance, allowing or blocking forwarding of the packet based on the first identity firewall policy.

9. The non-transitory computer-readable storage medium of claim 8, wherein tracking the context information comprises:
obtaining the first identity information specifying a primary user identifier (ID) that is used during a login process for the client device to establish the prior connection with the second computer system.

10. The non-transitory computer-readable storage medium of claim 8, wherein tracking the context information comprises:
obtaining the second identity information specifying a secondary user identifier (ID) that is used during a login process for the client device to establish the connection with the first computer system.

11. The non-transitory computer-readable storage medium of claim 8, wherein tracking the context information comprises:
tracking the context information that includes the first identity information, the second identity information and one or more of the following: (a) group membership information associated with the user; and (b) tuple information that includes source address information, source port number, destination address information and destination port number.

12. The non-transitory computer-readable storage medium of claim 8, wherein tracking the context information comprises:
obtaining the first identity information or the second identity information, or both, from one or more of the following: a context engine implemented by the second computer system, and a guest introspection agent associated with the virtualized computing instance.

13. The non-transitory computer-readable storage medium of claim 8, wherein detecting establishment of the connection comprises:
detecting a request to establish a remote desktop protocol (RDP) connection for the user to access at least one application implemented by the virtualized computing instance via the client device.

14. The non-transitory computer-readable storage medium of claim 8, wherein the method further comprises:
detecting a request to establish a further connection between the virtualized computing instance supported by the first computer system and a target virtualized computing instance supported by a third computer system; and
forwarding context information that includes the first identity information towards the third computer system to cause application of the first identity firewall policy associated with the first identity information on the third computer system.

15. A computer system, comprising:
a context engine to: detect establishment of a connection with a virtualized computing instance supported by the first computer system, wherein the establishment is initiated by a client device operated by a user; and track context information associated with the connection, wherein the context information includes (a) first identity information that is associated with a prior connection between the client device and a second computer system, and (ii) second identity information that is associated with the connection with the virtualized computing instance; and
a firewall engine to: obtain a first identity firewall policy associated with the first identity information, the first identity firewall policy being different from a second identity firewall policy associated with the second identity information; and in response to detecting a packet associated with a flow originating from, or destined for, the virtualized computing instance, allow or block forwarding of the packet based on the first identity firewall policy.

16. The computer system of claim 15, wherein the context engine is to track the context information by performing the following:
obtain the first identity information specifying a primary user identifier (ID) that is used during a login process for the client device to establish the prior connection with the second computer system.

17. The computer system of claim 15, wherein the context engine is to track the context information by performing the following:
obtain the second identity information specifying a secondary user identifier (ID) that is used during a login process for the client device to establish the connection with the first computer system.

18. The computer system of claim 15, wherein the context engine is to track the context information by performing the following:
track the context information that includes the first identity information, the second identity information and one or more of the following: (a) group membership information associated with the user; and (b) tuple information that includes source address information, source port number, destination address information and destination port number.

19. The computer system of claim 15, wherein the context engine is to track the context information by performing the following:
obtain the first identity information or the second identity information, or both, from one or more of the following: a context engine implemented by the second computer system, and a guest introspection agent associated with the virtualized computing instance.

20. The computer system of claim 15, wherein the context engine is to detect establishment of the connection by performing the following:
detect a request to establish a remote desktop protocol (RDP) connection for the user to access at least one application implemented by the virtualized computing instance via the client device.

21. The computer system of claim 15, wherein the context engine is further to:
detect a request to establish a further connection between the virtualized computing instance supported by the first computer system and a target virtualized computing instance supported by a third computer system; and
forward context information that includes the first identity information towards the third computer system to cause application of the first identity firewall policy associated with the first identity information on the third computer system.
